(19) United States
(12) Patent Application Publication
(10) Pub. No.: US 2026/0161992 A1
(43) Pub. Date: Jun. 11, 2026

(54) STITCHING NOISE MODEL PARAMETERS TO FORM A NOISE MODEL CONSIDERING CROSSTALK

(71) Applicant: International Business Machines Corporation, Armonk, NY (US)

(72) Inventors: Abigail McClain Gomez, Hartsdale, NY (US); Bradley K. Mitchell, San Jose, CA (US); Youngseok Kim, Montvale, NJ (US); Luke Colin Gene Govia, Sunnyvale, CA (US); Samantha Barron, Long Island City, NY (US); Swarnadeep Majumder, Durham, NC (US); Derek Wang, New York, NY (US)

(21) Appl. No.: 18/958,074

(22) Filed: Nov. 25, 2024

(51) Int. Cl. G06N 10/70; G06N 10/20; G06N 10/60

(52) U.S. Cl. CPC G06N 10/70; G06N 10/20; G06N 10/60

(57) ABSTRACT

A method, system, and computer program product for efficient noise model learning considering crosstalk. 2-qubit gate interactions of a quantum circuit in the presence of crosstalk are analyzed. Such an analysis may determine the direction that the crosstalk effects spread in the resulting noise model. The quantum circuit may then be decomposed into individual, unique layers. A subset of such layers (“abbreviated layers”) may be generated, where such abbreviated layers include an idle layer (layer where all qubits are idle) and one or more dense layers (layer where gates are densely packed without neighboring idle qubits) to achieve minimal graph coloring for hardware connectivity. Noise models may then be learned from such abbreviated layers. A noise model from the parameters (noise model parameters) of the learned noise models are stitched together to form a noise model for one or more of the individual, unique layers of the decomposed quantum circuit.

### TECHNICAL FIELD

The present disclosure relates generally to quantum error mitigation, and more particularly to stitching noise model parameters to form a noise model considering crosstalk.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

Current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation techniques have been developed. Quantum error mitigation refers to mitigating computation errors while keeping the hardware load to a minimum. That is, error mitigation is a technique that reduces the effects of noise and error on measured observables.

Some error mitigation techniques, such as probabilistic error cancellation, require noise model learning. Noise model learning refers to the process of understanding, characterizing, and simulating noise in quantum circuits. Such a task is time consuming, especially for quantum circuits comprised of many unique layers. Due to hardware drift (drift is any nontrivial time dependence in the outcome probabilities of quantum hardware), a noise model is not an accurate description of the quantum hardware's noise for arbitrary time scales. If too much time is devoted to learning a set of noise models, the noise models will become obsolete before they can be used defeating the purpose of error mitigation.

Consequently, these error mitigation techniques are limited to quantum circuits with only a few unique layers. Unfortunately, quantum circuits typically contain many unique layers.

As a result, a technique has been developed to perform noise model learning on a reduced number of layers of the quantum circuit, such as by stitching the noise model parameters from the learned noise models to form a “stitched noise model.” Stitching refers to joining noise model parameters from the learned noise models to form a new noise model, referred to as a stitched noise model.

Unfortunately, such a technique ignores crosstalk (unwanted interactions between neighboring qubits due to the architecture of the quantum hardware) by zeroing noise model parameters between the stitched noise model parameters thereby introducing systematic errors in the resulting stitched noise model.

### SUMMARY

In one embodiment of the present disclosure, a method for efficient noise model learning considering crosstalk comprises analyzing 2-qubit gate interactions of a quantum circuit in a presence of the crosstalk. The method further comprises decomposing the quantum circuit into individual layers. The method additionally comprises generating a plurality of abbreviated layers corresponding to a subset of the individual layers based on the analysis of the 2-qubit gate interactions in the presence of the crosstalk, where the plurality of abbreviated layers comprises an idle layer and one or more dense layers of pairs of 2-qubit gates to achieve a minimal graph coloring for hardware connectivity. Furthermore, the method comprises learning noise models of the plurality of abbreviated layers. Additionally, the method comprises stitching a noise model from noise model parameters of the learned noise models for one or more of the individual layers of the decomposed quantum circuit.

Furthermore, in one embodiment of the present disclosure, for 2-qubit gates that interact with the crosstalk in a single direction, the plurality of abbreviated layers comprises the idle layer and the one or more dense layers of pairs of 2-qubit gates to achieve the minimal graph coloring for hardware connectivity.

Additionally, in one embodiment of the present disclosure, for 2-qubit gates that interact with the crosstalk in each direction, the plurality of abbreviated layers comprises the idle layer, the one or more dense layers of pairs of 2-qubit gates to achieve the minimal graph coloring for hardware connectivity, and one or more additional layers that encompass a nearest neighbor context.

Furthermore, in one embodiment of the present disclosure, the nearest neighbor context comprises cases when 2-qubit gates are spaced by one idle qubit.

Additionally, in one embodiment of the present disclosure, the nearest neighbor context comprises cases when 2-qubit gates are densely packed without neighboring idle qubits that were not encompassed by the minimal graph coloring for hardware connectivity.

Furthermore, in one embodiment of the present disclosure, the method additionally comprises performing quasi-probabilistic error mitigation using the stitched noise model.

Additionally, in one embodiment of the present disclosure, the quasi-probabilistic error mitigation comprises probabilistic error cancellation or probabilistic error amplification.

Other forms of the embodiments of the method described above are in a system and in a computer program product.

Accordingly, embodiments of the present disclosure perform efficient noise model learning considering crosstalk by stitching noise model parameters to form a noise model considering crosstalk thereby reducing systematic errors in the resulting stitched noise model.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for performing efficient noise model learning considering crosstalk by stitching noise model parameters to form a noise model considering crosstalk thereby reducing systematic errors in the resulting stitched noise model in accordance with an embodiment of the present disclosure;

FIG. 3 illustrates decomposing a quantum circuit into individual, unique layers in accordance with an embodiment of the present disclosure;

FIG. 4 illustrates the abbreviated layers corresponding to a subset of the individual, unique layers of the decomposed quantum circuit that includes an idle layer, dense layers, and skip layers in accordance with an embodiment of the present disclosure;

FIG. 5 illustrates stitching the noise model parameters of the learned noise models to form the stitched noise model in accordance with an embodiment of the present disclosure;

FIG. 6 illustrates an embodiment of the present disclosure of the hardware configuration of the classical computer which is representative of a hardware environment for practicing the present disclosure; and

FIG. 7 is a flowchart of a method for performing efficient noise model learning considering crosstalk in accordance with an embodiment of the present disclosure.

### DETAILED DESCRIPTION

In one embodiment of the present disclosure, a method for efficient noise model learning considering crosstalk comprises analyzing 2-qubit gate interactions of a quantum circuit in a presence of the crosstalk. The method further comprises decomposing the quantum circuit into individual layers. The method additionally comprises generating a plurality of abbreviated layers corresponding to a subset of the individual layers based on the analysis of the 2-qubit gate interactions in the presence of the crosstalk, where the plurality of abbreviated layers comprises an idle layer and one or more dense layers of pairs of 2-qubit gates to achieve a minimal graph coloring for hardware connectivity. Furthermore, the method comprises learning noise models of the plurality of abbreviated layers. Additionally, the method comprises stitching a noise model from noise model parameters of the learned noise models for one or more of the individual layers of the decomposed quantum circuit.

In this manner, efficient noise model learning is performed considering crosstalk by stitching noise model parameters to form a noise model considering crosstalk thereby reducing systematic errors in the resulting stitched noise model.

Furthermore, in one embodiment of the present disclosure, for 2-qubit gates that interact with the crosstalk in a single direction, the plurality of abbreviated layers comprises the idle layer and the one or more dense layers of pairs of 2-qubit gates to achieve the minimal graph coloring for hardware connectivity.

In this manner, the context of the crosstalk effects involving gates that interact with crosstalk in one direction is captured.

Additionally, in one embodiment of the present disclosure, for 2-qubit gates that interact with the crosstalk in each direction, the plurality of abbreviated layers comprises the idle layer, the one or more dense layers of pairs of 2-qubit gates to achieve the minimal graph coloring for hardware connectivity, and one or more additional layers that encompass a nearest neighbor context.

In this manner, the context of the crosstalk effects involving gates that interact with crosstalk in each direction is captured.

Furthermore, in one embodiment of the present disclosure, the nearest neighbor context comprises cases when 2-qubit gates are spaced by one idle qubit.

In this manner, the context of the crosstalk effects involving 2-qubit gates spaced by one idle qubit is captured.

Additionally, in one embodiment of the present disclosure, the nearest neighbor context comprises cases when 2-qubit gates are densely packed without neighboring idle qubits that were not encompassed by the minimal graph coloring for hardware connectivity.

In this manner, the context of the crosstalk effects involving 2-qubit gates being densely packed without neighboring idle qubits that were not encompassed by the minimal graph coloring for hardware connectivity is captured.

Furthermore, in one embodiment of the present disclosure, the method additionally comprises performing quasi-probabilistic error mitigation using the stitched noise model.

In this manner, quasi-probabilistic error mitigation can be effectively performed using a stitched noise model that considers crosstalk.

Additionally, in one embodiment of the present disclosure, the quasi-probabilistic error mitigation comprises probabilistic error cancellation or probabilistic error amplification.

In this manner, quasi-probabilistic error mitigation, such as probabilistic error cancellation or probabilistic error amplification, can be effectively performed using a stitched noise model that considers crosstalk.

Other forms of the embodiments of the method described above are in a system and in a computer program product.

As stated above, quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

Current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation techniques have been developed. Quantum error mitigation refers to mitigating computation errors while keeping the hardware load to a minimum. That is, error mitigation is a technique that reduces the effects of noise and error on measured observables.

Some error mitigation techniques, such as probabilistic error cancellation, require noise model learning. Noise model learning refers to the process of understanding, characterizing, and simulating noise in quantum circuits. Such a task is time consuming, especially for quantum circuits comprised of many unique layers. Due to hardware drift (drift is any nontrivial time dependence in the outcome probabilities of quantum hardware), a noise model is not an accurate description of the quantum hardware's noise for arbitrary time scales. If too much time is devoted to learning a set of noise models, the noise models will become obsolete before they can be used defeating the purpose of error mitigation.

Consequently, these error mitigation techniques are limited to quantum circuits with only a few unique layers. Unfortunately, quantum circuits typically contain many unique layers.

As a result, a technique has been developed to perform noise model learning on a reduced number of layers of the quantum circuit, such as by stitching the noise model parameters from the learned noise models to form a “stitched noise model.” Stitching refers to joining noise model parameters from the learned noise models to form a new noise model, referred to as a stitched noise model.

Unfortunately, such a technique ignores crosstalk (unwanted interactions between neighboring qubits due to the architecture of the quantum hardware) by zeroing noise model parameters between the stitched noise model parameters thereby introducing systematic errors in the resulting stitched noise model.

The embodiments of the present disclosure provide the means for reducing systematic errors in the resulting stitched noise model by considering crosstalk. Crosstalk, as used herein, refers to the unwanted interactions between neighboring qubits due to the architecture of the quantum hardware. In one embodiment, 2-qubit gate interactions of a quantum circuit in the presence of crosstalk are analyzed. Such an analysis may determine the direction that the crosstalk effects spread in the resulting noise model. Examples of such analysis techniques include, but are not limited to, an analytical approach (e.g., dominating order of the Baker-Campbell-Hausdorff formula), a numerical approach (e.g., numerical simulation of noise), and machine learning. The quantum circuit (also referred to as the target quantum circuit) may then be decomposed into individual, unique layers. The target quantum circuit, as used herein, refers to the quantum circuit upon which to create a stitched noise model. A subset of such layers (referred to herein as the “abbreviated layers”) may be generated, where such abbreviated layers include an idle layer (layer where all qubits are idle) and one or more dense layers (layer where gates are densely packed without neighboring idle qubits) to achieve minimal graph coloring for hardware connectivity. In quantum circuit design, graph coloring is used to optimize the hardware connectivity by representing the qubits as nodes in a graph and representing connecting nodes (qubits) that need to interact with each other via quantum gates as edges in the graph. The goal is then to assign “colors” (representing different physical locations on the quantum chip) to each qubit such that no two connected qubits (adjacent nodes) have the same color thereby minimizing the need for qubit swaps or complex routing to perform desired operations due to limited physical connectivity. “Minimum graph coloring,” as used herein, refers to the minimum number of colors used for optimizing the hardware connectivity. In one embodiment, in order to account for crosstalk effects, the abbreviated layers may include additional context, such as the case when 2-qubit gates are densely packed without neighboring idle qubits as well as the case when 2-qubit gates are spaced by one idle qubit, where such context is learned from analyzing the 2-qubit gate interactions of the quantum circuit in the presence of crosstalk. Noise models may then be learned from such abbreviated layers (a minimal set of layers). A noise model from the parameters (noise model parameters) of the learned noise models (learned from abbreviated layers) are stitched together to form a noise model for one or more of the individual, unique layers of the decomposed quantum circuit (target quantum circuit). In this manner, such a stitched noise model takes into consideration crosstalk thereby reducing systematic errors in the resulting stitched noise model. These and other features will be discussed in further detail below.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

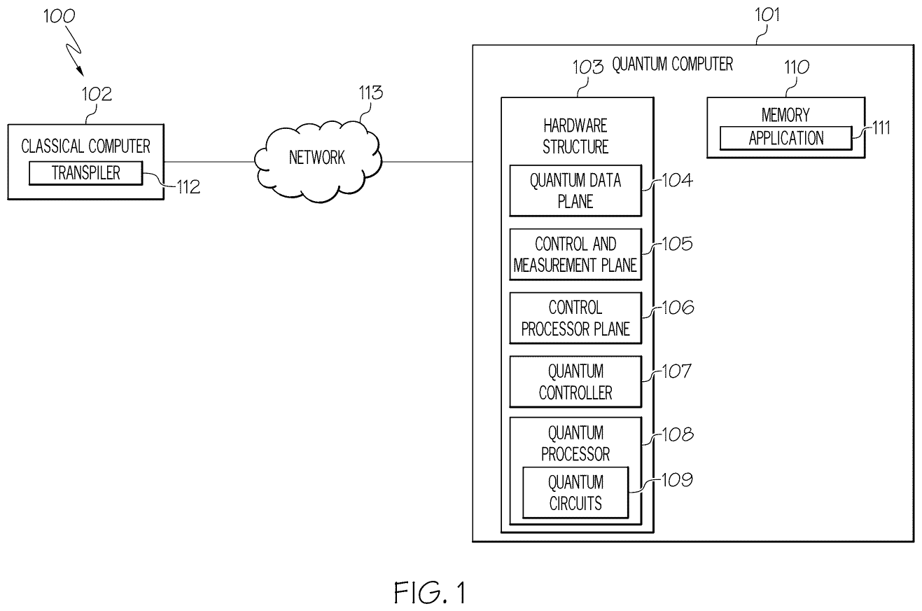

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to perform efficient noise model learning considering crosstalk by stitching noise model parameters to form a noise model considering crosstalk thereby reducing systematic errors in the resulting stitched noise model.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{iθX/2}, which corresponds to a rotation of the qubit state around the X-axis by the given angle theta θ on the Bloch sphere), RY (also identified as Ry) (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

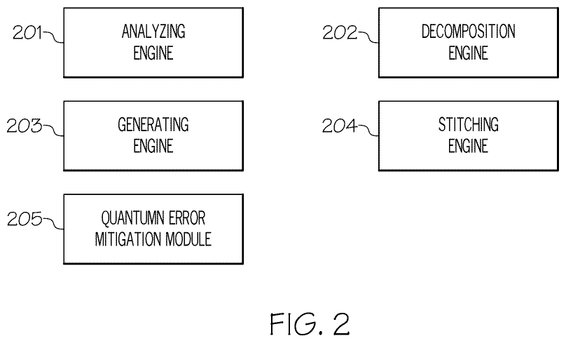

In one embodiment, memory 110 stores an application 111 that may be configured to implement one or more of the methods described herein in accordance with one or more embodiments. For example, application 111 may implement a program for performing efficient noise model learning considering crosstalk by stitching noise model parameters to form a noise model considering crosstalk thereby reducing systematic errors in the resulting stitched noise model as discussed further below in connection with FIGS. 2-5 and 7. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

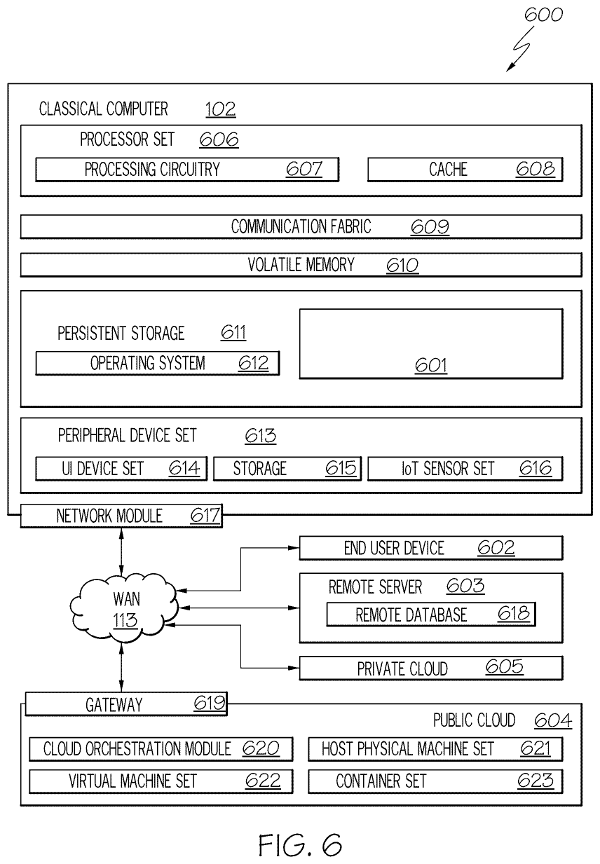

Furthermore, classical computer 102 is configured to perform efficient noise model learning considering crosstalk by stitching noise model parameters to form a noise model considering crosstalk thereby reducing systematic errors in the resulting stitched noise model as discussed further below in connection with FIGS. 2-5 and 7. A description of the software components of classical computer 102 is provided below in connection with FIG. 2 and a description of the hardware configuration of classical computer 102 is provided further below in connection with FIG. 6.

System 100 is not to be limited in scope to any one particular network architecture. System 100 may include any number of quantum computers 101, classical computers 102, and networks 113.

A discussion regarding the software components used by classical computer 102 for stitching noise model parameters to form a noise model considering crosstalk thereby reducing systematic errors in the resulting stitched noise model is provided below in connection with FIG. 2.

FIG. 2 is a diagram of the software components of classical computer 102 (FIG. 1) for performing efficient noise model learning considering crosstalk by stitching noise model parameters to form a noise model considering crosstalk thereby reducing systematic errors in the resulting stitched noise model in accordance with an embodiment of the present disclosure.

Referring to FIG. 2, in conjunction with FIG. 1, classical computer 102 includes analyzing engine 201 configured to analyze the interactions of the native 2-qubit gates of a quantum circuit (e.g., quantum circuit 109) in the presence of crosstalk. Crosstalk, as used herein, refers to the unwanted interactions between neighboring qubits due to the architecture of the quantum hardware.

In one embodiment, such an analysis determines the direction that the crosstalk effects spread in the resulting noise model. A noise model, as used herein, refers to a tool used to simulate the impact of noise on quantum algorithms. Noise in quantum computing refers to all the factors that can cause a quantum computer to malfunction, such as electromagnetic signals, disturbances on the Earth's magnetic field, cosmic rays, interactions between neighboring qubits, thermal fluctuations, imperfections in quantum gates, etc.

Analyzing engine 201 analyzes the interactions of the native 2-qubit gates of a quantum circuit (e.g., quantum circuit 109) in the presence of crosstalk in various manners, including, but not limited to, analytical approaches, numerical approaches, and machine learning. From such an analysis, the range of crosstalk effects may be determined and whether such effects depend on the context beyond the 2-qubit gate.

An example of an analytical approach is using the dominating orders of the Baker-Campbell-Hausdorff formula as discussed below.

For coherent crosstalk, the noise channel is modeled as:

$$Λ = {U}_{ideal}^{†} {U}_{noisy} ,$$

where U_{ideal} is the ideal two-qubit interaction and U_{noisy} represents the two-qubit interaction in the presence of crosstalk.

In one embodiment, the Baker-Campbell-Hausdorff (BCH) formula is used to compute the generators of A. In one embodiment, for typical levels of noise, the noise terms of the first order yield the primary crosstalk effects that extend beyond the 2-qubit gate. As a result, such an analysis determines whether these crosstalk effects are context-dependent.

For example, for a cross resonance (CR) gate (two-qubit entangling gate that uses microwaves to control superconducting qubits) in the presence of ZZ crosstalk:

$${U}_{ideal} = exp ( - {iH}_{CR} )$$

$${U}_{noisy} = exp ( - {iH}_{CR} - {iH}_{ZZ} )$$

The correction to the first order terms in H_{zz} is proportional to:

$${iH}_{ZZ} + \frac{1}{2} [ {H}_{CR} , {H}_{ZZ} ] - \frac{i}{12} [ {H}_{CR} , [ {H}_{CR} , {H}_{ZZ} ] ]$$

The nested commutator leads to additional ZZ terms extending beyond the CR gate, but only in one direction from the target qubit.

An example of a numerical approach for analyzing the interactions of the native 2-qubit gates of a quantum circuit (e.g., quantum circuit 109) in the presence of crosstalk is performing a numerical simulation of noise. Such a numerical simulation of noise may be performed using Cirq® or Qiskit®, which supports modeling noise via the operator sum representations of noise (these evaluations are also known as quantum operations or quantum dynamical maps).

In one embodiment, the interactions of the native 2-qubit gates of the quantum circuit in the presence of crosstalk are analyzed via simulating Λ resulting in a noise model with noise model parameters, such as the weight-2 noise model parameters. In one embodiment, the weight-2 noise model parameters are examined in a variety of contextual scenarios to determine whether crosstalk effects are context-dependent. In the context of quantum computing, “weight-1” and “weight-2” noise model parameters refer to the number of Pauli operators acting on a qubit during a noise process, where “weight-1” indicates a single Pauli operator affecting one qubit, and “weight-2” means two Pauli operators acting on two qubits.

As discussed above, in one embodiment, analyzing engine 201 analyzes the interactions of the native 2-qubit gates of the quantum circuit in the presence of crosstalk via machine learning.

In one embodiment, analyzing engine 201 determines the interactions of the native 2-qubit gates of the quantum circuit in the presence of crosstalk based on building and training a machine learning model to determine such interactions of the native 2-qubit gates of the quantum circuit in the presence of crosstalk.

In one embodiment, analyzing engine 201 trains the machine learning model to determine the interactions of the native 2-qubit gates of the quantum circuit in the presence of crosstalk based on a sample data set, which includes various interactions of the native 2-qubit gates of the quantum circuit in the presence of crosstalk. In one embodiment, such a sample data set is acquired using analytical or numerical approaches as discussed above. In one embodiment, such a sample data set is populated by an expert. In one embodiment, such a sample data set is stored in a storage device of classical computer 102.

Furthermore, in one embodiment, the sample data set discussed above is referred to herein as the “training data,” which is used by a machine learning algorithm to make predictions or decisions, such as determining the interactions of the native 2-qubit gates of the quantum circuit in the presence of crosstalk. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

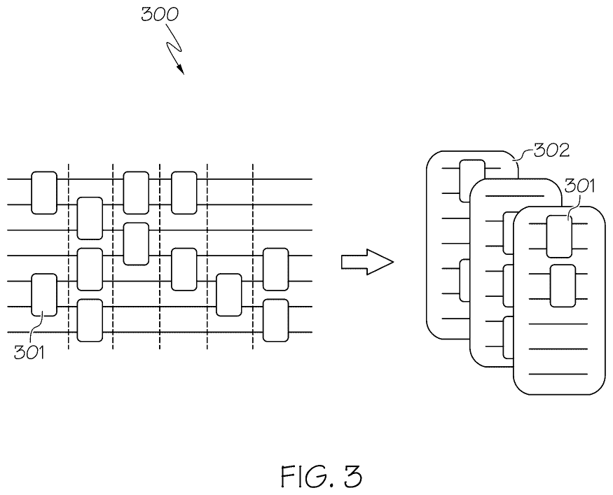

Classical computer 102 further includes decomposition engine 202 configured to decompose the quantum circuit (e.g., quantum circuit 109) (also referred to herein as the “target quantum circuit”) into individual, unique layers as illustrated in FIG. 3. The target quantum circuit, as used herein, refers to the quantum circuit upon which to create a stitched noise model.

Referring to FIG. 3, FIG. 3 illustrates decomposing a quantum circuit into individual, unique layers in accordance with an embodiment of the present disclosure.

As shown in FIG. 3, quantum circuit 300 of 2-qubit gates 301 is decomposed into individual, unique layers 302. A “layer 302,” as used herein, refers to a sequence of quantum gates 301.

In one embodiment, decomposition engine 202 decomposes the target quantum circuit, such as quantum circuit 300, into individual, unique layers, such as layers 302, using the DAGCircuit.layers( ) method in Qiskit®. In one embodiment, the DAGCircuit.layers( ) method constructs the layers using a greedy algorithm.

Returning to FIG. 2, classical computer 102 includes generating engine 203 configured to generate “abbreviated layers” corresponding to a subset of the individual, unique layers 302 that include an idle layer and one or more dense layers to achieve minimal graph coloring for hardware connectivity, and optionally, a skip layer(s) and an additional dense layer(s), using the analyzed interactions of the native 2-qubit gates of the quantum circuit in the presence of crosstalk.

An “idle layer,” as used herein, refers to a layer where all the qubits are idle. A “dense layer,” as used herein, refers to a layer of gates (e.g., 2-qubit gates) being densely packed without neighboring idle qubits.

In one embodiment, each edge associated with a 2-qubit gate in the target quantum circuit is covered by the generated dense layers. Such generated dense layers provide enough information to stitch together weight-1 and weight-2 noise model parameters for qubits involved in the 2-qubit gates.

In one embodiment, the abbreviated layers include an idle layer and one or more dense layers to achieve minimal graph coloring for hardware connectivity. In quantum circuit design, graph coloring is used to optimize the hardware connectivity by representing the qubits as nodes in a graph and representing connecting nodes (qubits) that need to interact with each other via quantum gates as edges in the graph. The goal is then to assign “colors” (representing different physical locations on the quantum chip) to each qubit such that no two connected qubits (adjacent nodes) have the same color thereby minimizing the need for qubit swaps or complex routing to perform desired operations due to limited physical connectivity. “Minimum graph coloring,” as used herein, refers to the minimum number of colors used for optimizing the hardware connectivity.

In one embodiment, in order to account for crosstalk effects, the abbreviated layers may include additional context, such as the case when 2-qubit gates are densely packed without neighboring idle qubits as well as the case when 2-qubit gates are spaced by one idle qubit, where such context is learned from analyzing the 2-qubit gate interactions of the quantum circuit in the presence of crosstalk.

In one embodiment, for 2-qubit gates that interact with crosstalk in one direction, such as a cross-resonance (CR) pulse, generating engine 203 generates an idle layer and one or more dense layers that achieve minimal graph coloring for hardware connectivity.

In one embodiment, for 2-qubit gates that interact with crosstalk in each direction, such as an echoed cross-resonance (ECR) pulse, generating engine 203 generates an idle layer and one or more dense layers that achieve minimal graph coloring for hardware connectivity as well as generates additional layers that encompass nearest neighbor context relevant for the target quantum circuit. For example, the nearest neighbor constraint, as used herein, refers to a physical restriction on quantum gates, which limits them to operating on adjacent qubits.

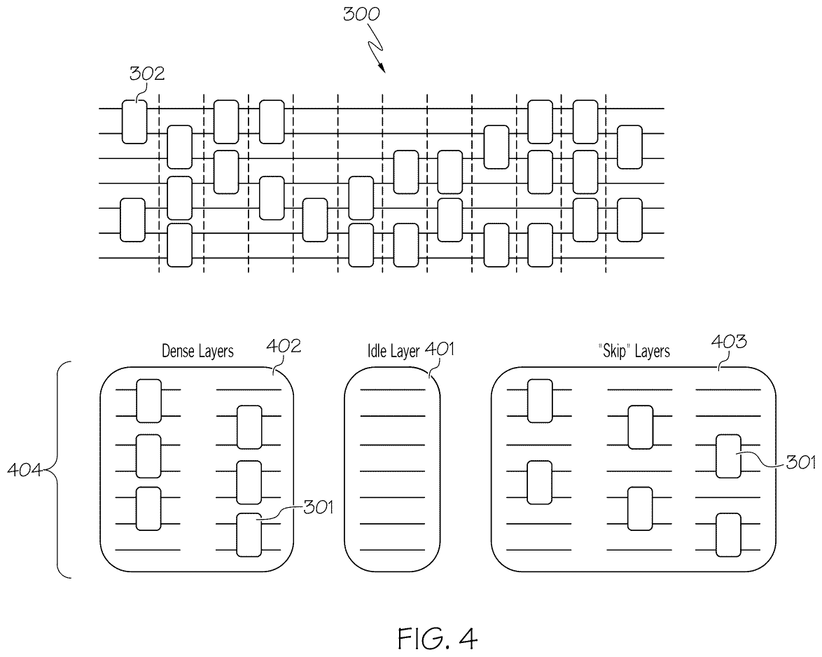

In one embodiment, the additional layers include “skip” layers generated by generating engine 203, where the nearest neighbor context is an idle qubit, as illustrated in FIG. 4. That is, such skip layers include idle qubits between the gates (e.g., 2-qubit gates). As a result, for arbitrary layers that can have neighboring idle qubits or neighboring gate qubits, the weight-2 noise model parameters extending from the edge to the neighbors can be taken from either the corresponding skip layer or the corresponding dense layer, respectively.

FIG. 4 illustrates the abbreviated layers corresponding to a subset of the individual, unique layers of the decomposed quantum circuit that includes an idle layer, dense layers, and skip layers in accordance with an embodiment of the present disclosure.

Referring to FIG. 4, in conjunction with FIGS. 1-3, quantum circuit 300 has been decomposed into 12 individual, unique layers 302 of 2-qubit gates 301. In one embodiment, generating engine 203 generates abbreviated layers 404 corresponding to a subset of such individual, unique layers 302 using the analyzed interactions of the native 2-qubit gates of the quantum circuit in the presence of crosstalk.

In one embodiment, such abbreviated layers 404 include an idle layer 401 (layer where all the qubits are idle) and dense layers 402 (layer of gates (e.g., 2-qubit gates) being densely packed without neighboring idle qubits), which together form the minimal graph coloring, and the additional skip layers 403, where the nearest neighbor context is an idle qubit.

As shown in FIG. 4, abbreviated layers 404, which include idle layer 401, dense layers 402, and skip layers 403, form a subset of the individual, unique layers 302 of the decomposed quantum circuit 300. For example, abbreviated layers 404 correspond to six (6) layers; whereas, the decomposed quantum circuit 300 has 12 unique layers 302.

Returning to FIG. 2, in one embodiment, the additional layers include an additional dense layer(s), such as beyond the minimal graph coloring, in order to account for neighbors (adjacent qubits) participating in gates (e.g., 2-qubit gates) not encompassed by the minimal graph coloring layers.

In one embodiment, the number of layers required for the abbreviated layers is reduced by strictly considering the gates (e.g., 2-qubit gates), and the context for those gates (e.g., 2-qubit gates) with crosstalk in each direction, of the layers comprising the target quantum circuit.

Classical computer 102 additionally includes stitching engine 204 configured to learn the noise models of the abbreviated layers (a minimal set of layers).

In one embedment, stitching engine 204 learns the noise models from the abbreviated layers (e.g., abbreviated layers 404 of FIG. 4) by executing the target quantum circuit with the abbreviated layers and then analyzing the resulting measurement data to identify patterns and characteristics of the noise present in each abbreviated layer thereby allowing a statistical model representing the noise behavior to be built. In one embodiment, stitching engine 204 uses machine learning algorithms to extract the relevant noise parameters from the data.

In one embodiment, stitching engine 204 learns the noise models from the abbreviated layers using the NoiseLearner class of Qiskit®.

In one embodiment, stitching engine 204 learns the noise models for each of the abbreviated layers (e.g., abbreviated layers 404 of FIG. 4) according to a noise learning protocol in which the abbreviated layers contain layers of noisy two-qubit gates interleaved with layers of single-qubit gates. In one embodiment, the noise across each layer of two-qubit gates is modeled as a sparse Pauli-Lindblad error model. In one embodiment, the noise channel is specific to the gates in the abbreviated layer and assumed to be a Pauli channel. In one embodiment, an n-qubit Pauli noise channel is modeled according to a Lindblad master equation. The model parameters are chosen to reflect the noise interactions in the quantum processor and their number, which determines the model complexity and expressivity, typically scales polynomially, and therefore enables one to represent noise models for the full device by a small set of nonnegative coefficients. In one embodiment, the model includes only weight-1 and weight-2 Pauli terms whose support coincides with the quantum processor's connectivity. The parameters of the resulting model scale linearly with the number of qubits, which ensures that the model is efficiently represented.

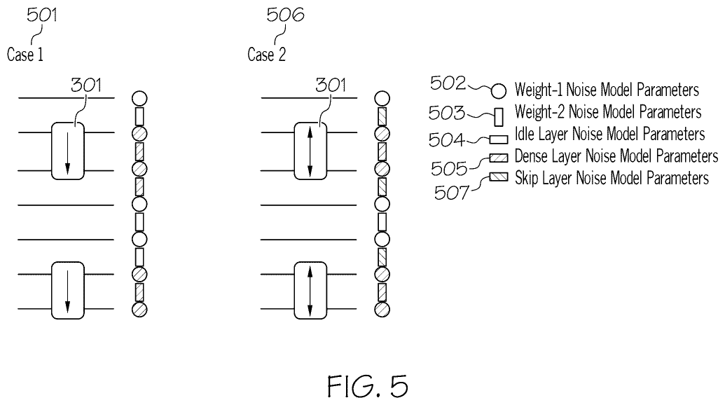

Furthermore, in one embodiment, stitching engine 204 is configured to stitch a noise model (“stitched noise model”) from the noise model parameters of the learned noise models for one or more of the individual, unique layers 302 of the decomposed quantum circuit 300 as illustrated in FIG. 5.

FIG. 5 illustrates stitching the noise model parameters of the learned noise models to form the stitched noise model in accordance with an embodiment of the present disclosure.

In particular, FIG. 5 illustrates the case (case #1 501) for stitching a noise model (“stitched noise model”) involving the scenario in which the gates 301 (e.g., 2-qubit gates) interact with crosstalk in a single direction. In such a case, the noise model parameters of the noise models learned for the abbreviated layers consisting of an idle layer 401 and dense layers 402 are stitched together. For example, the weight-1 noise model parameters 502 and the weight-2 noise model parameters 503 for idle layer 401 (correspond to idle layer noise model parameters 504) and dense layers 402 (correspond to dense layer noise model parameters 505) are stitched together to form the noise model (“stitched noise model”) as shown in FIG. 5 for case #1 501.

Furthermore, FIG. 5 illustrates the case (case #2 506) for stitching a noise model (“stitched noise model”) involving the scenario in which the gates 301 (e.g., 2-qubit gates) interact with crosstalk in each direction. In such a case, the noise model parameters of the noise models learned for the abbreviated layers consisting of an idle layer 401, dense layers 402, and skip layers 403 are stitched together. For example, the weight-1 noise model parameters 502 and the weight-2 noise model parameters 503 for idle layer 401 (correspond to idle layer noise model parameters 504), dense layers 402 (correspond to dense layer noise model parameters 505), and skip layers 403 (correspond to skip layer noise model parameters 507) are stitched together to form the noise model (“stitched noise model”) as shown in FIG. 5 for case #2 506.

In one embodiment, stitching engine 204 stitches the noise model parameters of the learned noise models for one or more of the individual, unique layers 302 of decomposed quantum circuit 300 using the context of the crosstalk effects learned from analyzing engine 201 as discussed above. Such context directly informs how stitching is to be accomplished.

In one embodiment, noise model parameters local to the domain of the context surrounding a particular gate 301 (e.g., 2-qubit gate) are taken from the corresponding learned model whose learning layer includes both the target gate (gate 301 of the target quantum circuit) and the matching context. For example, if the crosstalk effects extend only to the nearest neighbor (nearest neighbor context is an idle gate), then for each 2-qubit gate in a target layer (layer of the target quantum circuit), the weight-1 and weight-2 noise model parameters are obtained from the noise model whose layer included the same edge. For weight-2 noise model parameters extending beyond gate 301, a corresponding dense layer 402 or skip layer 403 may be utilized for obtaining such noise model parameters. Other noise model parameters may be obtained from the learned noise model of idle layer 401.

In one embodiment, stitching engine 204 stitches the noise model parameters of the learned noise models for one or more of the individual, unique layers 302 of the decomposed quantum circuit 300 using the Qiskit® Aer noise module.

In one embodiment, stitching engine 204 stitches a noise model from the noise model parameters of the learned noise models for one or more of the individual, unique layers 302 of the decomposed quantum circuit 300 using the sparse Pauli Lindblad model framework. For example, a sparse Pauli Lindblad noise model is a model for the noise acting on the quantum state of a noisy quantum computer under the action of a Clifford layer with Pauli twirling. Such noise models, such as the sparse Pauli Lindblad noise model, are learned according to a noise learning protocol, where each unique layer of gates in the quantum circuit has an associated noise model.

In one embodiment, stitching engine 204 combines the stitched noise models forming a complete set of noise models for the individual layers (e.g., individual layers 302) of the quantum circuit (e.g., quantum circuit 300). In one embodiment, stitching engine 204 forms a complete set of noise models for the individual layers (e.g., individual layers 302) of the quantum circuit (e.g., quantum circuit 300) by taking the union of the sparse Pauli Lindblad noise models describing the noise of each part of the layer. Furthermore, in one embodiment, stitching engine 204 forms a complete set of noise models for the individual layers (e.g., individual layers 302) of the quantum circuit (e.g., quantum circuit 300) by averaging over noise models that describe the same part of each layer. In this manner, the noise models for the individual layers of the decomposed quantum circuit can be learned before the learned noise models are no longer representative of the current device noise environment due to drifting device noise due to the fact that a reduced number of learning layers may be used to learn the noise models of the target quantum circuit. As a result of the reduced set of learning layers and using the reduced set of learning layers to learn the noise models for each of the individual layers of the quantum circuit, a complete set of noise models for the layers of the target quantum circuit can be learned before the learned noise models are no longer representative of the current device noise environment due to drifting device noise.

Classical computer 102 further includes quantum error mitigation module 205 configured to perform quasi-probabilistic error mitigation using the stitched noise model. Quasi-probabilistic error mitigation, as used herein, is a quantum error mitigation technique that uses a noisy quantum computer to simulate a noise-free one. Examples of quasi-probabilistic error mitigation include, but are not limited to, probabilistic error cancellation (technique that uses quantum circuits to generate estimates of expectation values that are free of error) or probabilistic error amplification (technique that uses preliminary experiments to reconstruct noise and then uses that information to amplify it accurately).

In this manner, a stitched noise model takes into consideration crosstalk thereby reducing systematic errors in the resulting stitched noise model.

A further description of these and other functions is provided below in connection with the discussion of the method for performing efficient noise model learning considering crosstalk.

Prior to the discussion of the method for performing efficient noise model learning considering crosstalk, a description of the hardware configuration of classical computer 102 (FIG. 1) is provided below in connection with FIG. 6.

Referring now to FIG. 6, in conjunction with FIG. 1, FIG. 6 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code 601 involved in performing the inventive methods, such as performing efficient noise model learning considering crosstalk by stitching noise model parameters to form a noise model considering crosstalk thereby reducing systematic errors in the resulting stitched noise model. In addition to block 601, computing environment 600 includes, for example, classical computer 102, network 113, such as a wide area network (WAN), end user device (EUD) 602, remote server 603, public cloud 604, and private cloud 605. In this embodiment, classical computer 102 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically classical computer 102, to keep the presentation as simple as possible. Classical computer 102 may be located in a cloud, even though it is not shown in a cloud in FIG. 6. On the other hand, classical computer 102 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto classical computer 102 to cause a series of operational steps to be performed by processor set 606 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 608 and the other storage media discussed below. The program instructions, and associated data, are accessed by processor set 606 to control and direct performance of the inventive methods. In computing environment 600, at least some of the instructions for performing the inventive methods may be stored in block 601 in persistent storage 611.

Communication fabric 609 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 610 is located in a single package and is internal to classical computer 102, but, alternatively or additionally, the volatile memory may be distributed over multiple packages and/or located externally with respect to classical computer 102.

Persistent Storage 611 is any form of non-volatile storage for computers that is now known or to be developed in the future. The non-volatility of this storage means that the stored data is maintained regardless of whether power is being supplied to classical computer 102 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid state storage devices. Operating system 612 may take several forms, such as various known proprietary operating systems or open source Portable Operating System Interface type operating systems that employ a kernel. The code included in block 601 typically includes at least some of the computer code involved in performing the inventive methods.

Peripheral device set 613 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows classical computer 102 to communicate with other computers through WAN 113. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the inventive methods can typically be downloaded to classical computer 102 from an external computer or external storage device through a network adapter card or network interface included in network module 617.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates classical computer 102), and may take any of the forms discussed above in connection with classical computer 102. EUD 602 typically receives helpful and useful data from the operations of classical computer 102. For example, in a hypothetical case where classical computer 102 is designed to provide a recommendation to an end user, this recommendation would typically be communicated from network module 617 of classical computer 102 through WAN 113 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to classical computer 102. Remote server 603 may be controlled and used by the same entity that operates classical computer 102. Remote server 603 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620. The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIGS. 2-5 to perform efficient noise model learning considering crosstalk by stitching noise model parameters to form a noise model considering crosstalk thereby reducing systematic errors in the resulting stitched noise model. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for performing efficient noise model learning considering crosstalk by stitching noise model parameters to form a noise model considering crosstalk thereby reducing systematic errors in the resulting stitched noise model, may be embodied in an application specific integrated circuit.

As stated above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation techniques have been developed. Quantum error mitigation refers to mitigating computation errors while keeping the hardware load to a minimum. That is, error mitigation is a technique that reduces the effects of noise and error on measured observables. Some error mitigation techniques, such as probabilistic error cancellation, require noise model learning. Noise model learning refers to the process of understanding, characterizing, and simulating noise in quantum circuits. Such a task is time consuming, especially for quantum circuits comprised of many unique layers. Due to hardware drift (drift is any nontrivial time dependence in the outcome probabilities of quantum hardware), a noise model is not an accurate description of the quantum hardware's noise for arbitrary time scales. If too much time is devoted to learning a set of noise models, the noise models will become obsolete before they can be used defeating the purpose of error mitigation. Consequently, these error mitigation techniques are limited to quantum circuits with only a few unique layers. Unfortunately, quantum circuits typically contain many unique layers. As a result, a technique has been developed to perform noise model learning on a reduced number of layers of the quantum circuit, such as by stitching the noise model parameters from the learned noise models to form a “stitched noise model.” Stitching refers to joining noise model parameters from the learned noise models to form a new noise model, referred to as a stitched noise model. Unfortunately, such a technique ignores crosstalk (unwanted interactions between neighboring qubits due to the architecture of the quantum hardware) by zeroing noise model parameters between the stitched noise model parameters thereby introducing systematic errors in the resulting stitched noise model.

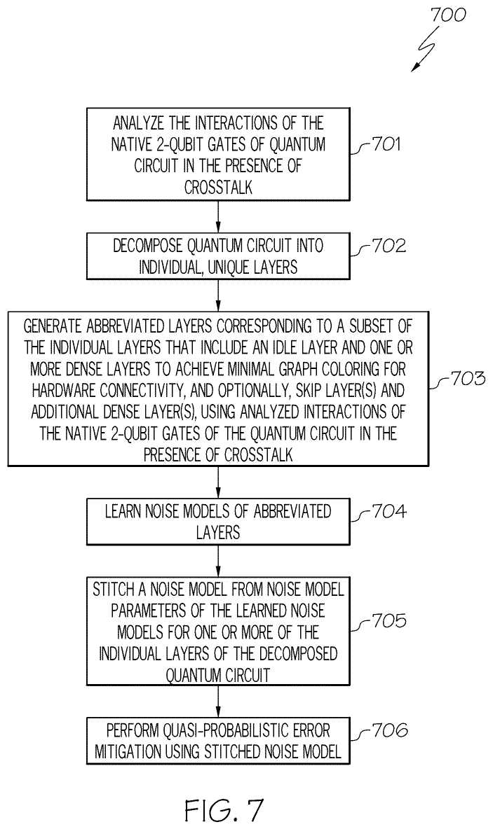

The embodiments of the present disclosure provide the means for reducing systematic errors in the resulting stitched noise model by considering crosstalk as discussed below in connection with FIG. 7.

FIG. 7 is a flowchart of a method 700 for performing efficient noise model learning considering crosstalk in accordance with an embodiment of the present disclosure.

Referring to FIG. 7, in conjunction with FIGS. 1-6, in step 701, analyzing engine 201 of classical computer 102 analyzes the interactions of the native 2-qubit gates of a quantum circuit (e.g., quantum circuit 109) in the presence of crosstalk. Crosstalk, as used herein, refers to the unwanted interactions between neighboring qubits due to the architecture of the quantum hardware.

As discussed above, in one embodiment, such an analysis determines the direction that the crosstalk effects spread in the resulting noise model. A noise model, as used herein, refers to a tool used to simulate the impact of noise on quantum algorithms. Noise in quantum computing refers to all the factors that can cause a quantum computer to malfunction, such as electromagnetic signals, disturbances on the Earth's magnetic field, cosmic rays, interactions between neighboring qubits, thermal fluctuations, imperfections in quantum gates, etc.

Analyzing engine 201 analyzes the interactions of the native 2-qubit gates of a quantum circuit (e.g., quantum circuit 109) in the presence of crosstalk in various manners, including, but not limited to, analytical approaches, numerical approaches, and machine learning. From such an analysis, the range of crosstalk effects may be determined and whether such effects depend on the context beyond the 2-qubit gate.

An example of an analytical approach is using the dominating orders of the Baker-Campbell-Hausdorff formula as discussed below.

For coherent crosstalk, the noise channel is modeled as:

$$Λ = {U}_{ideal}^{†} {U}_{noisy} ,$$

where U_{ideal} is the ideal two-qubit interaction and U_{noisy} represents the two-qubit interaction in the presence of crosstalk.

In one embodiment, the Baker-Campbell-Hausdorff (BCH) formula is used to compute the generators of Λ. In one embodiment, for typical levels of noise, the noise terms of the first order yield the primary crosstalk effects that extend beyond the 2-qubit gate. As a result, such an analysis determines whether these crosstalk effects are context-dependent.

For example, for a cross resonance (CR) gate (two-qubit entangling gate that uses microwaves to control superconducting qubits) in the presence of ZZ crosstalk:

$${U}_{ideal} = exp ( - {iH}_{CR} )$$

$${U}_{noisy} = exp ( - {iH}_{CR} - {iH}_{ZZ} )$$

The correction to the first order terms in H_{zz} is proportional to:

$${iH}_{ZZ} + \frac{1}{2} [ {H}_{CR} , {H}_{ZZ} ] - \frac{i}{12} [ {H}_{CR} , [ {H}_{CR} , {H}_{ZZ} ] ]$$

The nested commutator leads to additional ZZ terms extending beyond the CR gate, but only in one direction from the target qubit.

An example of a numerical approach for analyzing the interactions of the native 2-qubit gates of a quantum circuit (e.g., quantum circuit 109) in the presence of crosstalk is performing a numerical simulation of noise. Such a numerical simulation of noise may be performed using Cirq® or Qiskit®, which supports modeling noise via the operator sum representations of noise (these evaluations are also known as quantum operations or quantum dynamical maps).

In one embodiment, the interactions of the native 2-qubit gates of the quantum circuit in the presence of crosstalk are analyzed via simulating A resulting in a noise model with noise model parameters, such as the weight-2 noise model parameters. In one embodiment, the weight-2 noise model parameters are examined in a variety of contextual scenarios to determine whether crosstalk effects are context-dependent. In the context of quantum computing, “weight-1” and “weight-2” noise model parameters refer to the number of Pauli operators acting on a qubit during a noise process, where “weight-1” indicates a single Pauli operator affecting one qubit, and “weight-2” means two Pauli operators acting on two qubits.

As discussed above, in one embodiment, analyzing engine 201 analyzes the interactions of the native 2-qubit gates of the quantum circuit in the presence of crosstalk via machine learning.

In one embodiment, analyzing engine 201 determines the interactions of the native 2-qubit gates of the quantum circuit in the presence of crosstalk based on building and training a machine learning model to determine such interactions of the native 2-qubit gates of the quantum circuit in the presence of crosstalk.

In one embodiment, analyzing engine 201 trains the machine learning model to determine the interactions of the native 2-qubit gates of the quantum circuit in the presence of crosstalk based on a sample data set, which includes various interactions of the native 2-qubit gates of the quantum circuit in the presence of crosstalk. In one embodiment, such a sample data set is acquired using analytical or numerical approaches as discussed above. In one embodiment, such a sample data set is populated by an expert. In one embodiment, such a sample data set is stored in a storage device (e.g., storage device 611, 615) of classical computer 102.

Furthermore, in one embodiment, the sample data set discussed above is referred to herein as the “training data,” which is used by a machine learning algorithm to make predictions or decisions, such as determining the interactions of the native 2-qubit gates of the quantum circuit in the presence of crosstalk. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

In step 702, decomposition engine 202 of classical computer 102 decomposes the quantum circuit (e.g., quantum circuit 109) (also referred to herein as the “target quantum circuit”) into individual, unique layers as illustrated in FIG. 3.

As stated above, as shown in FIG. 3, quantum circuit 300 of 2-qubit gates 301 is decomposed into individual, unique layers 302. A “layer 302,” as used herein, refers to a sequence of quantum gates 301.

In one embodiment, decomposition engine 202 decomposes the target quantum circuit, such as quantum circuit 300, into individual, unique layers, such as layers 302, using the DAGCircuit.layers( ) method in Qiskit®. In one embodiment, the DAGCircuit.layers( ) method constructs the layers using a greedy algorithm.

In step 703, generating engine 203 of classical computer 102 generates the “abbreviated layers” corresponding to a subset of the individual, unique layers 302 that include an idle layer 401 and one or more dense layers 402 to achieve minimal graph coloring for hardware connectivity, and optionally, a skip layer(s) 403 and an additional dense layer(s), using the analyzed interactions of the native 2-qubit gates of the quantum circuit in the presence of crosstalk.

As discussed above, an “idle layer,” as used herein, refers to a layer where all the qubits are idle. A “dense layer,” as used herein, refers to a layer of gates (e.g., 2-qubit gates) being densely packed without neighboring idle qubits.

In one embodiment, each edge associated with a 2-qubit gate in the target quantum circuit is covered by the generated dense layers. Such generated dense layers provide enough information to stitch together weight-1 and weight-2 noise model parameters for qubits involved in the 2-qubit gates.

In one embodiment, the abbreviated layers include idle layer 401 and one or more dense layers 402 to achieve minimal graph coloring for hardware connectivity. In quantum circuit design, graph coloring is used to optimize the hardware connectivity by representing the qubits as nodes in a graph and representing connecting nodes (qubits) that need to interact with each other via quantum gates as edges in the graph. The goal is then to assign “colors” (representing different physical locations on the quantum chip) to each qubit such that no two connected qubits (adjacent nodes) have the same color thereby minimizing the need for qubit swaps or complex routing to perform desired operations due to limited physical connectivity. “Minimum graph coloring,” as used herein, refers to the minimum number of colors used for optimizing the hardware connectivity.

In one embodiment, in order to account for crosstalk effects, the abbreviated layers may include additional context, such as the case when 2-qubit gates are densely packed without neighboring idle qubits as well as the case when 2-qubit gates are spaced by one idle qubit, where such context is learned from analyzing the 2-qubit gate interactions of the quantum circuit in the presence of crosstalk.

In one embodiment, for 2-qubit gates that interact with crosstalk in one direction, such as a cross-resonance (CR) pulse, generating engine 203 generates idle layer 401 and one or more dense layers 402 that achieve minimal graph coloring for hardware connectivity.

In one embodiment, for 2-qubit gates that interact with crosstalk in each direction, such as an echoed cross-resonance (ECR) pulse, generating engine 203 generates idle layer 401 and one or more dense layers 402 that achieve minimal graph coloring for hardware connectivity as well as generates additional layers that encompass nearest neighbor context relevant for the target quantum circuit. For example, the nearest neighbor constraint, as used herein, refers to a physical restriction on quantum gates, which limits them to operating on adjacent qubits.

In one embodiment, the additional layers include “skip” layers 403 generated by generating engine 203, where the nearest neighbor context is an idle qubit, as illustrated in FIG. 4. That is, such skip layers 403 include idle qubits between the gates (e.g., 2-qubit gates). As a result, for arbitrary layers that can have neighboring idle qubits or neighboring gate qubits, the weight-2 noise model parameters extending from the edge to the neighbors can be taken from either the corresponding skip layer or the corresponding dense layer, respectively.

Referring to FIG. 4, in conjunction with FIGS. 1-3, quantum circuit 300 has been decomposed into 12 individual, unique layers 302 of 2-qubit gates 301. In one embodiment, generating engine 203 generates abbreviated layers 404 corresponding to a subset of such individual, unique layers 302 using the analyzed interactions of the native 2-qubit gates of the quantum circuit in the presence of crosstalk.

In one embodiment, such abbreviated layers 404 include an idle layer 401 (layer where all the qubits are idle) and dense layers 402 (layer of gates (e.g., 2-qubit gates) being densely packed without neighboring idle qubits), which together form the minimal graph coloring, and the additional skip layers 403, where the nearest neighbor context is an idle qubit.

As shown in FIG. 4, abbreviated layers 404, which include idle layer 401, dense layers 402, and skip layers 403, form a subset of the individual, unique layers 302 of the decomposed quantum circuit 300. For example, abbreviated layers 404 correspond to six (6) layers; whereas, the decomposed quantum circuit 300 has 12 unique layers 302.

Furthermore, in one embodiment, the additional layers include an additional dense layer(s), such as beyond the minimal graph coloring, in order to account for neighbors (adjacent qubits) participating in gates (e.g., 2-qubit gates) not encompassed by the minimal graph coloring layers.

In one embodiment, the number of layers required for the abbreviated layers is reduced by strictly considering the gates (e.g., 2-qubit gates), and the context for those gates (e.g., 2-qubit gates) with crosstalk in each direction, of the layers comprising the target quantum circuit.

In step 704, stitching engine 204 of classical computer 102 learns the noise models of the abbreviated layers (a minimal set of layers).

As stated above, in one embedment, stitching engine 204 learns the noise models from the abbreviated layers (e.g., abbreviated layers 404 of FIG. 4) by executing the target quantum circuit with the abbreviated layers and then analyzing the resulting measurement data to identify patterns and characteristics of the noise present in each abbreviated layer thereby allowing a statistical model representing the noise behavior to be built. In one embodiment, stitching engine 204 uses machine learning algorithms to extract the relevant noise parameters from the data.

In one embodiment, stitching engine 204 learns the noise models from the abbreviated layers using the NoiseLearner class of Qiskit®.

In one embodiment, stitching engine 204 learns the noise models for each of the abbreviated layers (e.g., abbreviated layers 404 of FIG. 4) according to a noise learning protocol in which the abbreviated layers contain layers of noisy two-qubit gates interleaved with layers of single-qubit gates. In one embodiment, the noise across each layer of two-qubit gates is modeled as a sparse Pauli-Lindblad error model. In one embodiment, the noise channel is specific to the gates in the abbreviated layer and assumed to be a Pauli channel. In one embodiment, an n-qubit Pauli noise channel is modeled according to a Lindblad master equation. The model parameters are chosen to reflect the noise interactions in the quantum processor and their number, which determines the model complexity and expressivity, typically scales polynomially, and therefore enables one to represent noise models for the full device by a small set of nonnegative coefficients. In one embodiment, the model includes only weight-1 and weight-2 Pauli terms whose support coincides with the quantum processor's connectivity. The parameters of the resulting model scale linearly with the number of qubits, which ensures that the model is efficiently represented.

In step 705, stitching engine 204 of classical computer 102 stitches a noise model from the noise model parameters of the learned noise models for one or more of the individual, unique layers 302 of decomposed quantum circuit 300

As discussed above, in one embodiment, stitching engine 204 is configured to stitch a noise model (“stitched noise model”) from the noise model parameters of the learned noise models for one or more of the individual, unique layers 302 of the decomposed quantum circuit 300 as illustrated in FIG. 5.

FIG. 5 illustrates the case (case #1 501) for stitching a noise model (“stitched noise model”) involving the scenario in which the gates 301 (e.g., 2-qubit gates) interact with crosstalk in a single direction. In such a case, the noise model parameters of the noise models learned for the abbreviated layers consisting of an idle layer 401 and dense layers 402 are stitched together. For example, the weight-1 noise model parameters 502 and the weight-2 noise model parameters 503 for idle layer 401 (correspond to idle layer noise model parameters 504) and dense layers 402 (correspond to dense layer noise model parameters 505) are stitched together to form the noise model (“stitched noise model”) as shown in FIG. 5 for case #1 501.

Furthermore, FIG. 5 illustrates the case (case #2 506) for stitching a noise model (“stitched noise model”) involving the scenario in which the gates 301 (e.g., 2-qubit gates) interact with crosstalk in each direction. In such a case, the noise model parameters of the noise models learned for the abbreviated layers consisting of an idle layer 401, dense layers 402, and skip layers 403 are stitched together. For example, the weight-1 noise model parameters 502 and the weight-2 noise model parameters 503 for idle layer 401 (correspond to idle layer noise model parameters 504), dense layers 402 (correspond to dense layer noise model parameters 505), and skip layers 403 (correspond to skip layer noise model parameters 507) are stitched together to form the noise model (“stitched noise model”) as shown in FIG. 5 for case #2 506.

In one embodiment, stitching engine 204 of classical computer 102 stitches the noise model parameters of the learned noise models for one or more of the individual, unique layers 302 of decomposed quantum circuit 300 using the context of the crosstalk effects learned from analyzing engine 201 as discussed above. Such context directly informs how stitching is to be accomplished.

As discussed above, in one embodiment, noise model parameters local to the domain of the context surrounding a particular gate 301 (e.g., 2-qubit gate) are taken from the corresponding learned model whose learning layer includes both the target gate (gate 301 of the target quantum circuit) and the matching context. For example, if the crosstalk effects extend only to the nearest neighbor (nearest neighbor context is an idle gate), then for each 2-qubit gate in a target layer (layer of the target quantum circuit), the weight-1 and weight-2 noise model parameters are obtained from the noise model whose layer included the same edge. For weight-2 noise model parameters extending beyond gate 301, a corresponding dense layer 402 or skip layer 403 may be utilized for obtaining such noise model parameters. Other noise model parameters may be obtained from the learned noise model of idle layer 401.

In one embodiment, stitching engine 204 stitches the noise model parameters of the learned noise models for one or more of the individual, unique layers 302 of the decomposed quantum circuit 300 using the Qiskit® Aer noise module.

In one embodiment, stitching engine 204 stitches a noise model from the noise model parameters of the learned noise models for one or more of the individual, unique layers 302 of the decomposed quantum circuit 300 using the sparse Pauli Lindblad model framework. For example, a sparse Pauli Lindblad noise model is a model for the noise acting on the quantum state of a noisy quantum computer under the action of a Clifford layer with Pauli twirling. Such noise models, such as the sparse Pauli Lindblad noise model, are learned according to a noise learning protocol, where each unique layer of gates in the quantum circuit has an associated noise model.

In one embodiment, stitching engine 204 combines the stitched noise models forming a complete set of noise models for the individual layers (e.g., individual layers 302) of the quantum circuit (e.g., quantum circuit 300). In one embodiment, stitching engine 204 forms a complete set of noise models for the individual layers (e.g., individual layers 302) of the quantum circuit (e.g., quantum circuit 300) by taking the union of the sparse Pauli Lindblad noise models describing the noise of each part of the layer. Furthermore, in one embodiment, stitching engine 204 forms a complete set of noise models for the individual layers (e.g., individual layers 302) of the quantum circuit (e.g., quantum circuit 300) by averaging over noise models that describe the same part of each layer. In this manner, the noise models for the individual layers of the decomposed quantum circuit can be learned before the learned noise models are no longer representative of the current device noise environment due to drifting device noise due to the fact that a reduced number of learning layers may be used to learn the noise models of the target quantum circuit. As a result of the reduced set of learning layers and using the reduced set of learning layers to learn the noise models for each of the individual layers of the quantum circuit, a complete set of noise models for the layers of the target quantum circuit can be learned before the learned noise models are no longer representative of the current device noise environment due to drifting device noise.

In step 706, quantum error mitigation module 205 of classical computer 102 performs quasi-probabilistic error mitigation using the stitched noise model. Quasi-probabilistic error mitigation, as used herein, is a quantum error mitigation technique that uses a noisy quantum computer to simulate a noise-free one. Examples of quasi-probabilistic error mitigation include, but are not limited to, probabilistic error cancellation (technique that uses quantum circuits to generate estimates of expectation values that are free of error) or probabilistic error amplification (technique that uses preliminary experiments to reconstruct noise and then uses that information to amplify it accurately).

In this manner, a stitched noise model takes into consideration crosstalk thereby reducing systematic errors in the stitched noise model.

Furthermore, the principles of the present disclosure improve the technology or technical field involving quantum error mitigation.

As discussed above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation techniques have been developed. Quantum error mitigation refers to mitigating computation errors while keeping the hardware load to a minimum. That is, error mitigation is a technique that reduces the effects of noise and error on measured observables. Some error mitigation techniques, such as probabilistic error cancellation, require noise model learning. Noise model learning refers to the process of understanding, characterizing, and simulating noise in quantum circuits. Such a task is time consuming, especially for quantum circuits comprised of many unique layers. Due to hardware drift (drift is any nontrivial time dependence in the outcome probabilities of quantum hardware), a noise model is not an accurate description of the quantum hardware's noise for arbitrary time scales. If too much time is devoted to learning a set of noise models, the noise models will become obsolete before they can be used defeating the purpose of error mitigation. Consequently, these error mitigation techniques are limited to quantum circuits with only a few unique layers. Unfortunately, quantum circuits typically contain many unique layers. As a result, a technique has been developed to perform noise model learning on a reduced number of layers of the quantum circuit, such as by stitching the noise model parameters from the learned noise models to form a “stitched noise model.” Stitching refers to joining noise model parameters from the learned noise models to form a new noise model, referred to as a stitched noise model. Unfortunately, such a technique ignores crosstalk (unwanted interactions between neighboring qubits due to the architecture of the quantum hardware) by zeroing noise model parameters between the stitched noise model parameters thereby introducing systematic errors in the resulting stitched noise model.

Embodiments of the present disclosure improve such technology by analyzing 2-qubit gate interactions of a quantum circuit in the presence of crosstalk. Such an analysis may determine the direction that the crosstalk effects spread in the resulting noise model. Examples of such analysis techniques include, but are not limited to, an analytical approach (e.g., dominating order of the Baker-Campbell-Hausdorff formula), a numerical approach (e.g., numerical simulation of noise), and machine learning. The quantum circuit (also referred to as the target quantum circuit) may then be decomposed into individual, unique layers. The target quantum circuit, as used herein, refers to the quantum circuit upon which to create a stitched noise model. A subset of such layers (referred to herein as the “abbreviated layers”) may be generated, where such abbreviated layers include an idle layer (layer where all qubits are idle) and one or more dense layers (layer where gates are densely packed without neighboring idle qubits) to achieve minimal graph coloring for hardware connectivity. In quantum circuit design, graph coloring is used to optimize the hardware connectivity by representing the qubits as nodes in a graph and representing connecting nodes (qubits) that need to interact with each other via quantum gates as edges in the graph. The goal is then to assign “colors” (representing different physical locations on the quantum chip) to each qubit such that no two connected qubits (adjacent nodes) have the same color thereby minimizing the need for qubit swaps or complex routing to perform desired operations due to limited physical connectivity. “Minimum graph coloring,” as used herein, refers to the minimum number of colors used for optimizing the hardware connectivity. In one embodiment, in order to account for crosstalk effects, the abbreviated layers may include additional context, such as the case when 2-qubit gates are densely packed without neighboring idle qubits as well as the case when 2-qubit gates are spaced by one idle qubit, where such context is learned from analyzing the 2-qubit gate interactions of the quantum circuit in the presence of crosstalk. Noise models may then be learned from such abbreviated layers (a minimal set of layers). A noise model from the parameters (noise model parameters) of the learned noise models (learned from abbreviated layers) are stitched together to form a noise model for one or more of the individual, unique layers of the decomposed quantum circuit (target quantum circuit). In this manner, such a stitched noise model takes into consideration crosstalk thereby reducing systematic errors in the resulting stitched noise model. Furthermore, in this manner, there is an improvement in the technical field involving quantum error mitigation.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for efficient noise model learning considering crosstalk, the method comprising:
analyzing 2-qubit gate interactions of a quantum circuit in a presence of said crosstalk;
decomposing said quantum circuit into individual layers;
generating a plurality of abbreviated layers corresponding to a subset of said individual layers based on said analysis of said 2-qubit gate interactions in said presence of said crosstalk, wherein said plurality of abbreviated layers comprises an idle layer and one or more dense layers of pairs of 2-qubit gates to achieve a minimal graph coloring for hardware connectivity;
learning noise models of said plurality of abbreviated layers; and
stitching a noise model from noise model parameters of said learned noise models for one or more of said individual layers of said decomposed quantum circuit.

2. The method as recited in claim 1, wherein for 2-qubit gates that interact with said crosstalk in a single direction, said plurality of abbreviated layers comprises said idle layer and said one or more dense layers of pairs of 2-qubit gates to achieve said minimal graph coloring for hardware connectivity.

3. The method as recited in claim 1, wherein for 2-qubit gates that interact with said crosstalk in each direction, said plurality of abbreviated layers comprises said idle layer, said one or more dense layers of pairs of 2-qubit gates to achieve said minimal graph coloring for hardware connectivity, and one or more additional layers that encompass a nearest neighbor context.

4. The method as recited in claim 3, wherein said nearest neighbor context comprises cases when 2-qubit gates are spaced by one idle qubit.

5. The method as recited in claim 3, wherein said nearest neighbor context comprises cases when 2-qubit gates are densely packed without neighboring idle qubits that were not encompassed by said minimal graph coloring for hardware connectivity.

6. The method as recited in claim 1 further comprising:
performing quasi-probabilistic error mitigation using said stitched noise model.

7. The method as recited in claim 6, wherein said quasi-probabilistic error mitigation comprises probabilistic error cancellation or probabilistic error amplification.

8. A computer program product for efficient noise model learning considering crosstalk, the computer program product comprising one or more computer readable storage mediums having program code embodied therewith, the program code comprising programming instructions for:
analyzing 2-qubit gate interactions of a quantum circuit in a presence of said crosstalk;
decomposing said quantum circuit into individual layers;
generating a plurality of abbreviated layers corresponding to a subset of said individual layers based on said analysis of said 2-qubit gate interactions in said presence of said crosstalk, wherein said plurality of abbreviated layers comprises an idle layer and one or more dense layers of pairs of 2-qubit gates to achieve a minimal graph coloring for hardware connectivity;
learning noise models of said plurality of abbreviated layers; and
stitching a noise model from noise model parameters of said learned noise models for one or more of said individual layers of said decomposed quantum circuit.

9. The computer program product as recited in claim 8, wherein for 2-qubit gates that interact with said crosstalk in a single direction, said plurality of abbreviated layers comprises said idle layer and said one or more dense layers of pairs of 2-qubit gates to achieve said minimal graph coloring for hardware connectivity.

10. The computer program product as recited in claim 8, wherein for 2-qubit gates that interact with said crosstalk in each direction, said plurality of abbreviated layers comprises said idle layer, said one or more dense layers of pairs of 2-qubit gates to achieve said minimal graph coloring for hardware connectivity, and one or more additional layers that encompass a nearest neighbor context.

11. The computer program product as recited in claim 10, wherein said nearest neighbor context comprises cases when 2-qubit gates are spaced by one idle qubit.

12. The computer program product as recited in claim 10, wherein said nearest neighbor context comprises cases when 2-qubit gates are densely packed without neighboring idle qubits that were not encompassed by said minimal graph coloring for hardware connectivity.

13. The computer program product as recited in claim 8, wherein the program code further comprises the programming instructions for:
performing quasi-probabilistic error mitigation using said stitched noise model.

14. The computer program product as recited in claim 13, wherein said quasi-probabilistic error mitigation comprises probabilistic error cancellation or probabilistic error amplification.

15. A system, comprising:
a memory for storing a computer program for efficient noise model learning considering crosstalk; and
a processor connected to said memory, wherein said processor is configured to execute program instructions of the computer program comprising:
analyzing 2-qubit gate interactions of a quantum circuit in a presence of said crosstalk;
decomposing said quantum circuit into individual layers;
generating a plurality of abbreviated layers corresponding to a subset of said individual layers based on said analysis of said 2-qubit gate interactions in said presence of said crosstalk, wherein said plurality of abbreviated layers comprises an idle layer and one or more dense layers of pairs of 2-qubit gates to achieve a minimal graph coloring for hardware connectivity;
learning noise models of said plurality of abbreviated layers; and
stitching a noise model from noise model parameters of said learned noise models for one or more of said individual layers of said decomposed quantum circuit.

16. The system as recited in claim 15, wherein for 2-qubit gates that interact with said crosstalk in a single direction, said plurality of abbreviated layers comprises said idle layer and said one or more dense layers of pairs of 2-qubit gates to achieve said minimal graph coloring for hardware connectivity.

17. The system as recited in claim 15, wherein for 2-qubit gates that interact with said crosstalk in each direction, said plurality of abbreviated layers comprises said idle layer, said one or more dense layers of pairs of 2-qubit gates to achieve said minimal graph coloring for hardware connectivity, and one or more additional layers that encompass a nearest neighbor context.

18. The system as recited in claim 17, wherein said nearest neighbor context comprises cases when 2-qubit gates are spaced by one idle qubit.

19. The system as recited in claim 17, wherein said nearest neighbor context comprises cases when 2-qubit gates are densely packed without neighboring idle qubits that were not encompassed by said minimal graph coloring for hardware connectivity.

20. The system as recited in claim 15, wherein the program instructions of the computer program further comprise:
performing quasi-probabilistic error mitigation using said stitched noise model.
